(19) United States
(12) Patent Application Publication
(10) Pub. No.: US 2011/0221689 A1
(43) Pub. Date: Sep. 15, 2011

(54) OPERATION INPUT DEVICE

(75) Inventor: Tohru Nanri, Narashino-shi (JP)

(73) Assignee: Buffalo Inc., Nagoya-shi (JP)

(21) Appl. No.: 13/005,951

(22) Filed: Jan. 13, 2011

(30) Foreign Application Priority Data
Jan. 13, 2010 (JP) P2010-005139

(51) Int. Cl. G06F 3/041

(52) U.S. Cl. 345/173

(57) ABSTRACT

In the operation input device 1, the strip-shaped touch sensor 20 is provided on the side surfaces 13, 14, 15, which are parallel with the Z axis, of the case 10 shaped like a rectangular solid. The normal line to the portion of the strip-shaped touch sensor 20 on the side surface 13 and the normal line to the portion thereof on the side surface 15 are in directions opposite from each other.

### CROSS REFERENCE TO RELATED APPLICATION

This application is based upon and claims the benefit of priority from, the prior Japanese Patent Application No. 2010-5139 filed on Jan. 13, 2010; the entire contents of which are incorporated herein by reference.

### BACKGROUND OF THE INVENTION

1. Field of the Invention

This invention relates to an operation input device in various apparatuses that is operated by a user.

2. Description of the Related Art

Heretofore, devices that detect various touches made by a user and perform operation inputs corresponding to the touches have been in widespread use. For example, in a technique described in Japanese Patent Application Publication 2008-52062, a touch sensor is provided on a peripheral portion of a display unit for displaying an image and is substantially flush with the display unit.

However, in the technique in Japanese Patent Application No. 2008-52062, a user presses down the touch sensor in a touch operation on the touch sensor for an operation, and this press-down operation causes a problem of making the display unit and a case that includes the display unit unstable.

With this taken into consideration, an object of this invention is to provide an operation input device operable by a user while a case is kept stable.

### SUMMARY OF THE INVENTION

To achieve the object, this invention has the following features. A first feature of this invention is summarized in that an operation input device includes: a case; a planer display unit (display 50); and a touch sensor (touch sensor 20) configured to detect a touch position and provided at a position including at least two points at which normal lines to the touch sensor are in directions opposite from each other on a surface (side surfaces 13, 14, and 15) of the case perpendicular to an extending direction of the display unit.

In such an operation input device, the touch sensor is provided on the surface of the case perpendicular to the extending direction of the display unit, and includes at least two points at which the respective normal lines to the touch sensor are in directions opposite from each other. Thus, the user can perform various operations by touching the touch sensor at two points while holding the operation input sensor with a thumb and another finger. Thus, the user can perform operations without pressing down the touch sensor. In addition, the case is kept stable during operations, because the user holds the case with the thumb and the finger during the operations.

A second feature of this invention is summarized in that the case is shaped like a rectangular solid, and the touch sensor is provided on three of four side surfaces of the rectangular solid.

A third feature of this invention is summarized in that the operation input device further includes a display controller (controller 70) configured to control the display unit so that the display unit displays an image based on a result of touch position detection by the touch sensor.

A fourth feature of this invention is summarized in that the display controller controls the display unit so that the display unit displays an image based on at least one of the touch position, a movement amount of the touch position, and a movement direction of the touch position that are detected by the touch sensor.

A fifth feature of this invention is summarized in that the display unit is provided on the case.

A sixth feature of this invention is summarized in that the display controller controls the display unit so that the display unit performs image display in which an object represented by an image is dragged, when at least two touch positions detected by the touch sensor move in a direction parallel with the extending direction of the display unit.

A seventh feature of this invention is summarized in that the display controller controls the display unit so that the display unit performs image display in which an object represented by the image is grabbed, when at least two touch positions detected by the touch sensor move in a direction from the rear side to the front side of the display unit.

An eighth feature of this invention is summarized in that the display controller controls the display unit so that the display unit performs image display in which an object represented by the image is pushed in, when at least two touch positions detected by the touch sensor move in a direction from the front side to the rear side of the display unit.

A ninth feature of this invention is summarized in that the display controller controls the display unit so that the display unit performs image display in which an object represented by the image is twisted, when one of at least two touch positions detected by the touch sensor moves in a direction from the rear side to the front side of the display unit and the other thereof moves in a direction from the front side to the rear side of the display unit.

A tenth feature of this invention is summarized in that the display controller controls the display unit so that the display unit displays an image in which an object represented by the image is pulled up, when at least two touch positions detected by the touch sensor move in a direction from the rear side to the front side of the display unit.

An eleventh feature of this invention is summarized in that the display controller controls the display unit so that the display unit displays an image in which an object represented by the image is pushed down, when at least two touch positions detected by the touch sensor move in a direction from the front side to the rear side of the display unit.

This invention makes it possible for the user to perform an operation while the case is stabilized.

### BRIEF DESCRIPTION OF THE DRAWINGS

FIGS. 1A and 1B are each a perspective view of an outer appearance of an operation input device according to an embodiment of this invention.

FIG. 2 is a configuration diagram of the operation input device according to the embodiment of this invention.

FIGS. 3A and 3B are diagrams each showing an example of a display screen of a display unit according to the embodiment of this invention.

FIG. 4 is a perspective view of an outer appearance of an operation input device according to a first different embodiment of this invention.

FIG. 5 is a perspective view of an outer appearance of an operation input device according to a second different embodiment of this invention.

FIG. 6 is a perspective view of an outer appearance of an operation input device according to a third different embodiment of this invention.

### DESCRIPTION OF THE EMBODIMENTS

Embodiments of this invention are described below with reference to the drawings. In the drawings of the embodiments below, same or similar reference signs denote same or similar portions.

It should be noted that the drawings are schematic and the ratios of dimensions are different from actual ones

Hereinbelow, descriptions will be sequentially provided for (1) a configuration of an operation input device, (2) an operation of the operation input device, (3) operation/working effect, and (4) other embodiments.

### (1) Configuration of Operation Input Device

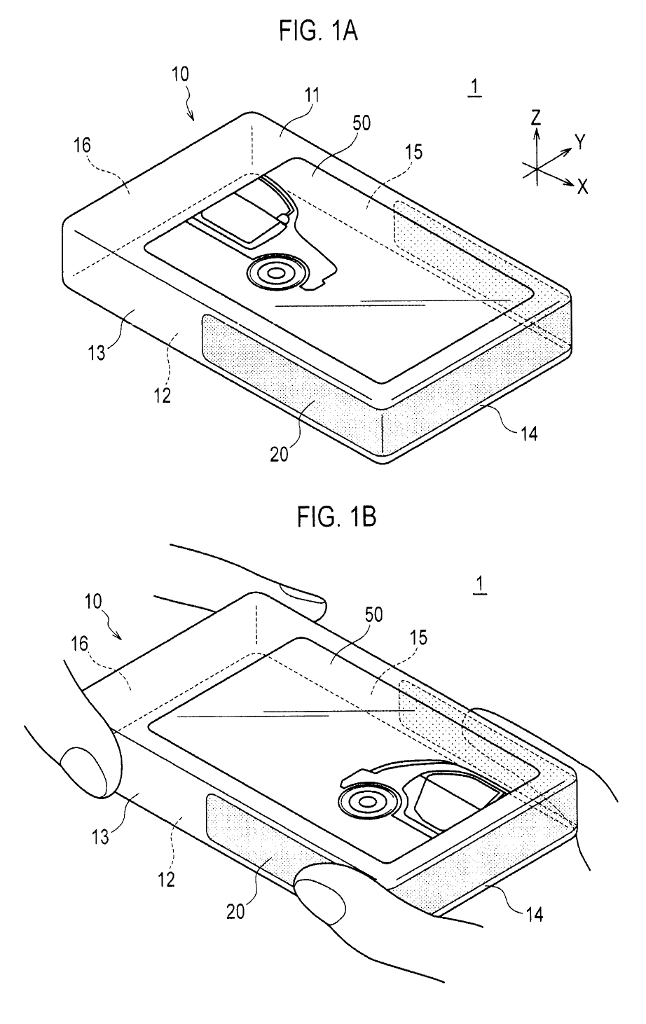

To begin with, a configuration of an operation input device 1 is described. FIGS. 1A and 1B are each a perspective view of an outer appearance of an operation input device according to an embodiment of this invention.

As illustrated in FIG. 1A, the operation input device 1 includes a case 10, a touch sensor 20, and a display 50.

The case 10 is shaped like a rectangular solid, and is formed of a front surface 11, a rear surface 12, and four side surfaces 13, 14, 15, 16 between the front surface 11 and the rear surface 12. The four side surfaces four 13, 14, 15, 16 are surfaces parallel with the Z axis.

The front surface 11 of the case 10 is provided with the display 50.

The strip-shaped touch sensor 20 is provided on the three side surfaces 13, 14, 15 of the four side surfaces 13, 14, 15, 16 of the case 10. Because the strip-shaped touch sensor 20 is provided on the three side surfaces 13, 14, 15 as described above, a normal line to a portion of the strip-shaped touch sensor 20 on the side surface 13 and a normal line to a portion thereof on the side surface 15 are in directions opposite from each other.

The touch sensor 20 detects a touch position when a finger of a user or another thing touches the touch sensor 20. The touch position can be acquired as, for example, coordinate information. As illustrated in FIG. 1B, while holding the operation input device 1 with one hand, the user can perform operation instruction by touching the touch sensor 20 with the thumb and a finger (e.g., the index finger) of the other hand.

The display 50 displays an image corresponding to the touch operation performed on the touch sensor 20 by the user and other images.

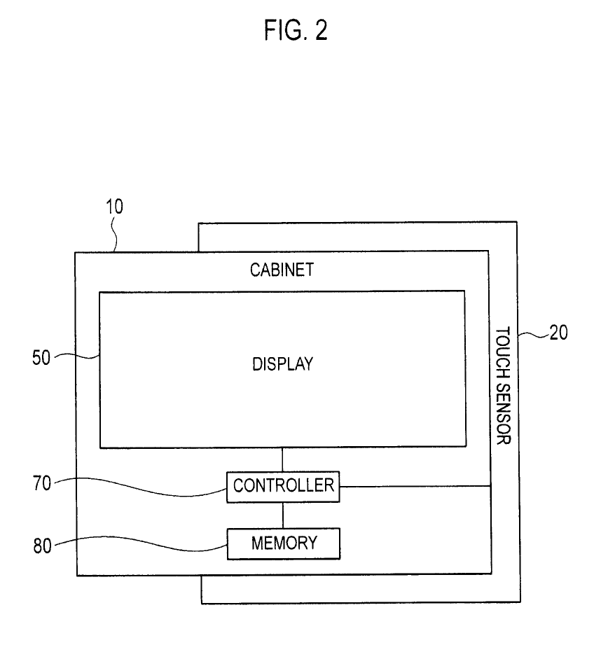

As illustrated in FIG. 2, a controller 70 and a storage unit 80 are provided in the case 10.

The controller 70 is formed of a CPU, for example, and controls various functions of the operation input device 1. The storage unit 80 is formed of a memory, for example, and stores therein various pieces of information used for control in the operation input device 1.

### (2) Operation of Operation Input Device

An operation of the operation input device 1 is described below. The touch sensor 20 outputs touch position information indicating the touch position to the controller 70 as needed while the user is touching the touch sensor 20. In this operation, when the user touches the touch sensor 20 at multiple positions, the touch sensor 20 outputs coordinate information indicating each of the touch positions to the controller 70.

The controller 70 receives the touch position information outputted from the touch sensor 20 as needed while the user is touching the touch sensor 20. The controller 70 then identifies the touch position, a movement amount of the touch position, and a movement direction of the touch position based on the received touch position information.

The controller 70 makes control for the display 50 to display an image based on the touch position, the movement amount of the touch position, and the movement direction of the touch position that have been identified.

Specifically, the controller 70 performs the following first to sixth image controls when the user touches a portion of the touch sensor 20 on the side surface 13 of the case 10 with the thumb and touches a portion thereof on the side surface 15 of the case 10 with the index finger, as illustrated in FIG. 1B.

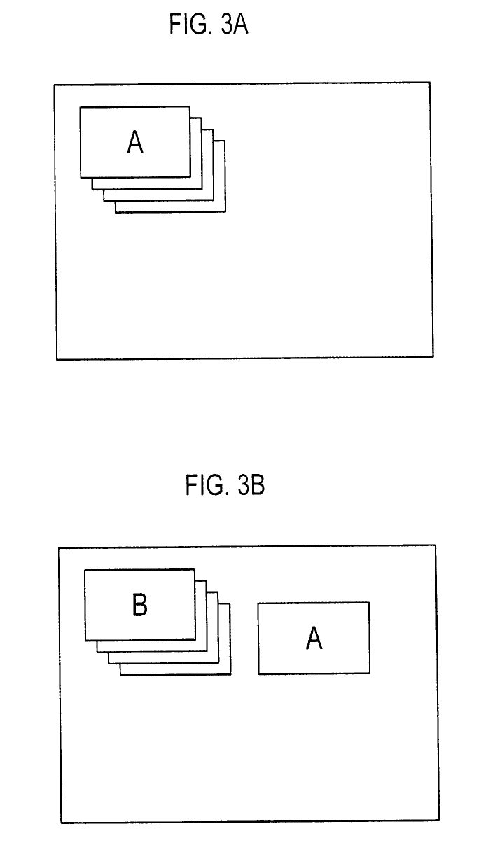

In the first image control, a first touch position is on a portion of the touch sensor 20 on the side surface 13 of the case 10, and a second touch position is on a portion thereof on the side surface 15. The first and second touch positions each move by a predetermined amount in a direction within a predetermined angle (for example, 10 degrees) to the +direction of the X axis in FIG. 1A. In this case, the controller 70 controls the display 50 so that the display 50 may perform image display in which an object represented in an image is dragged to move in a predetermined direction corresponding to the +direction of the X axis by a movement amount proportional to the mean value of the movement amounts of the respective first and the second touch positions. FIGS. 3A and 3B are diagrams each showing an example of an image displayed on the display 50. In FIG. 3, reference sings A and B are photo images. Here, suppose a case where, while the photo images are overlapped as shown in FIG. 3A, the first image control is performed in which: the first touch position is on the portion of the touch sensor 20 on the side surface 13 of the case 10; the second touch position is on the portion thereof on the side surface 15; and the first and the second touch positions each moves by the predetermined amount in the direction within the predetermined angle to the +direction of the X axis in FIG. 1A. In this case, the controller 70 performs such a control that: the foremost photo image A is moved in the predetermined direction corresponding to the +direction of the X axis by an amount proportional to the mean value of the movement amounts of the respective first and the second touch positions; and thereby the photo image B becomes the foremost image.

In the second image control, the first touch position is on the portion of the touch sensor 20 on the side surface 13 of the case 10, and the second touch position is on the portion thereof on the side surface 15. The first and second touch positions each move in a direction within a predetermined angle (for example, 10 degrees) to the +direction of the axis Z in FIG. 1A. In this case, the controller 70 controls the display 50 so that the display 50 may perform image display in which the object represented by the image is grabbed.

In the third image control, the first touch position is on the portion of the touch sensor 20 on the side surface 13 of the case 10, and the second touch position is on the portion thereof on the side surface 15. The first and second touch positions each move in a direction within a predetermined angle (for example, 10 degrees) to the − direction of the Z axis in FIG. 1A. In this case, the controller 70 controls the display 50 so that the display 50 may perform image display in which the object represented by the image is pushed in.

In the fourth image control, the first touch position is on the portion of the touch sensor 20 on the side surface 13 of the case 10, and the second touch position is on the portion thereof on the side surface 15. The first touch position moves in the direction within the predetermined angle (for example, 10 degrees) to the + direction of the Z axis in FIG. 1A, while the second touch position moves in the direction within the predetermined angle (for example, 10 degrees) to the − direction of the Z axis in FIG. 1A. In this case, the controller 70 controls the display 50 so that the display 50 may perform image display in which the object represented by the image is twisted.

In the fifth image control, the first touch position is on the portion of the touch sensor 20 on the side surface 13 of the case 10, and the second touch position is on the portion thereof on the side surface 15. The first and second touch positions each move in the direction within the predetermined angle (for example, 10 degrees) to the + direction of the Z axis in FIG. 1A. In this case, the controller 70 controls the display 50 so that the display 50 may perform image display in which the object represented by the image is pulled up.

In the sixth image control, the first touch position is on the portion of the touch sensor 20 on the side surface 13 of the case 10, and the second touch position is on the portion thereof on the side surface 15. The first and second touch positions each move in the direction within the predetermined angle (for example, 10 degrees) to the − direction of the Z axis in FIG. 1A. In this case, the controller 70 controls the display 50 so that the display 50 may perform image display in which the object represented by the image is pushed down.

The controller 70 performs the following image control in addition to the above-described first to sixth image controls. Specifically, the first touch position is on a portion of the touch sensor 20 on the side surface 14 of the case 10, and the first touch positions moves in the direction within the predetermined angle (for example, 10 degrees) to the − direction of the Z axis in FIG. 1A. In this case, the controller 70 controls the display 50 so that the display 50 may perform image display in which the object represented by the image is turned over or the object represented by the image is cut.

### (3) Operation/Working-Effect

In the operation input device 1, the strip-shaped touch sensor 20 is provided on the side surfaces 13, 14, 15, which are parallel with the Z axis, of the case 10 shaped like a rectangular solid. The normal line to the portion of the strip-shaped touch sensor 20 on the side surface 13 and the normal line to the portion thereof on the side surface 15 are in directions opposite from each other.

Thus, the user can perform various operations by touching the touch sensor 20 at two points with the case 10 held between the thumb and another finger. Accordingly, the user can perform operations without pressing down the touch sensor 20. Moreover, the case 10 is kept stable during operations, because the user holds the case 10 with the thumb and another finger during the operations.

The controller 70 identifies touch positions, movement amounts of the touch positions, and movement direction of the touch positions based on the touch position information outputted from the touch sensor 20 as needed while the user is touching the touch sensor 20. The controller 70 then makes control to show image display in which a state of an object represented by an image is changed based on the touch positions, the movement amounts of the touch positions, and the movement directions of the touch positions that have been identified. This makes it possible to perform the image display in which the operation of the user is appropriately reflected.

Conventionally, since a touch sensor has been provided on a peripheral portion of a display portion for displaying an image while substantially flush with the display portion, the user cannot perform operation involving a movement in a direction orthogonal to the display unit while touching the touch sensor. For this reason, image control based on an operation is limited. On the other hand, in this embodiment, the user can perform control involving a movement in any of the X, Y, and Z directions while touching the touch sensor. Thus, the image control based on an operation is more flexible.

This invention has been disclosed by using the embodiment of this invention. However, it should not be understood that the description and drawings which constitute part of this disclosure limit this invention. From this disclosure, various alternative embodiments, examples and operation techniques will be easily found by those skilled in the art.

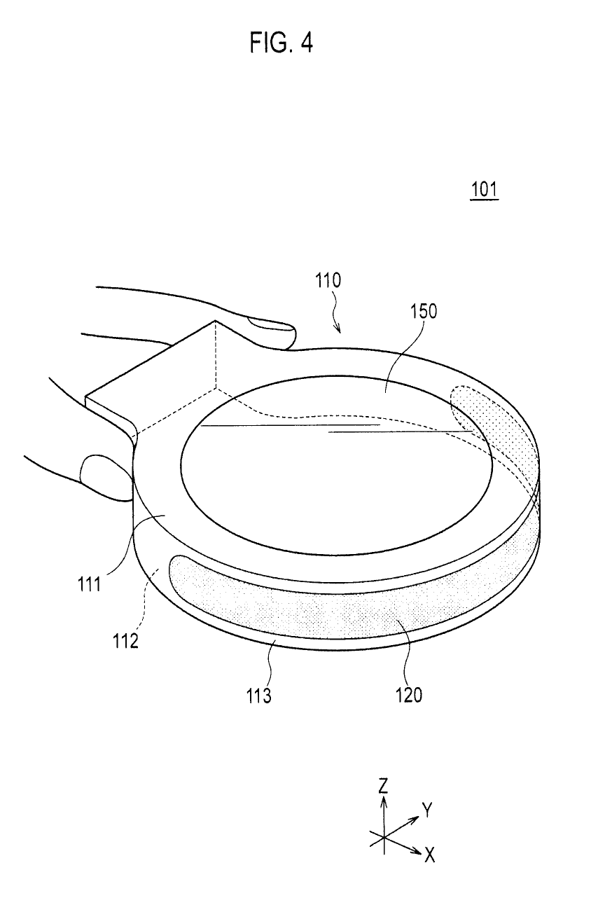

FIG. 4 is a perspective view of an outer appearance of an operation input device 101 according to a first different embodiment of this invention. As illustrated in FIG. 4, the operation input device 101 includes a case 110, a touch sensor 120, and a display 150.

The case 110 is shaped like a disk, and is formed of a front surface 111, a rear surface 112, and a side surface 113 having a curbed shape between the front surface 111 and the rear surface 112. The side surface 113 is a surface parallel with the Z axis.

The front surface 111 of the case 110 is provided with the display 150.

The side surface 113 of the case 110 is provided with the strip-shaped touch sensor 120. Because the strip-shaped touch sensor 120 is provided on the side surface 113 as described above, the touch sensor 120 includes two points at which the respective normal lines to the touch sensor 120 are in directions opposite from each other.

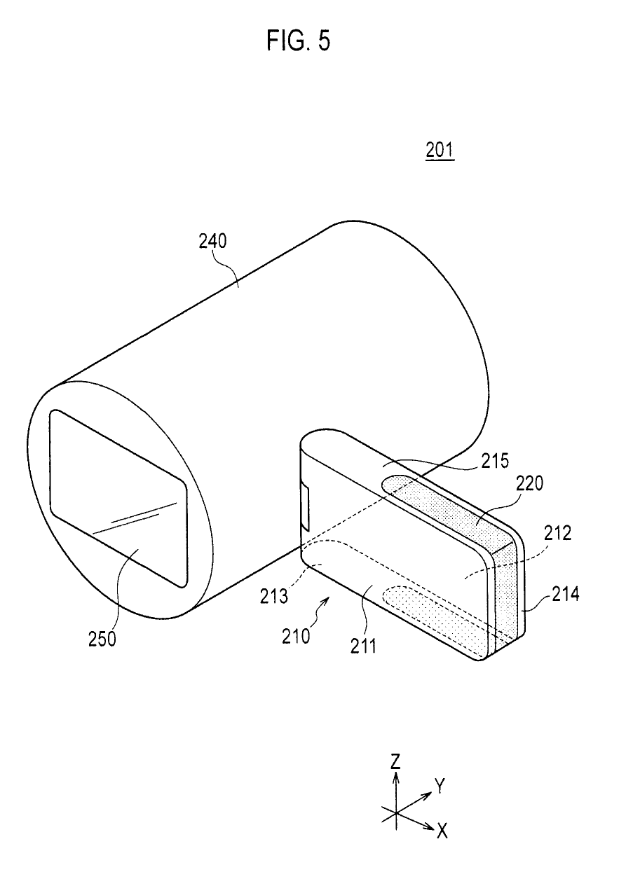

FIG. 5 is a perspective view of an outer appearance of an operation input device 201 according to a second different embodiment of this invention. As illustrated in FIG. 5, the operation input device 201 includes a case 210, a touch sensor 220, and a display 250.

The case 210 is shaped like a rectangular solid, and includes four side surfaces. It is to be noted that side surfaces 213, 214, 215 are surfaces parallel with the Z axis.

The case 210 is mounted on the other case 240. The case 240 is provided with the display 250. Incidentally, in addition to the display 250, the case 210 may be provided with a display as shown in FIGS. 1A and 1B.

The strip-shaped touch sensor 220 is provided on the side surfaces 213, 214, 215. Because the strip-shaped touch sensor 220 is provided on the side surfaces 213, 214, 215 as described above, a normal line to a portion of the touch sensor 220 on the side surface 213 and a normal line to a portion thereof on the side surface 215 are in directions opposite from each other.

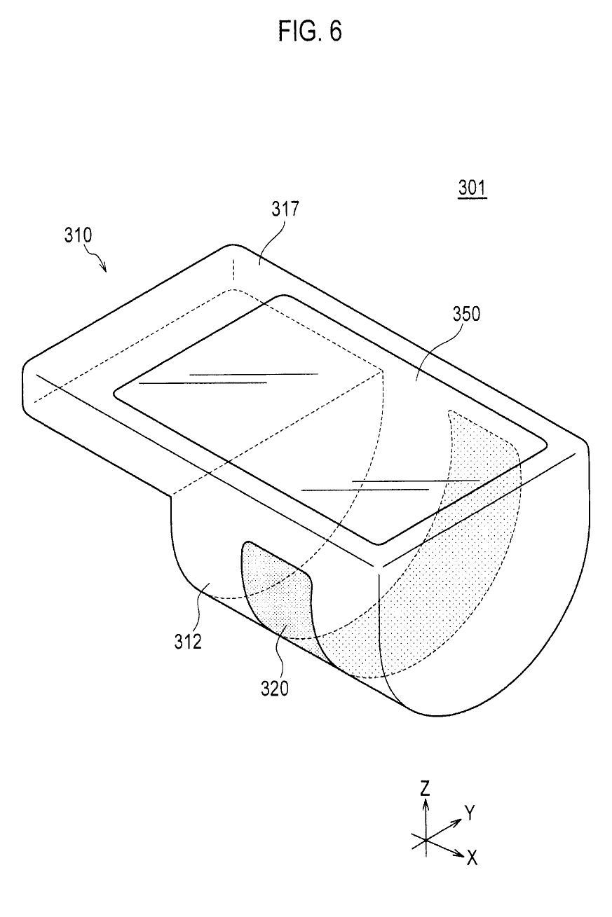

FIG. 6 is a perspective view of an outer appearance of an operation input device 301 according to a third different embodiment. As shown in FIG. 6, the operation input device 301 includes a case 310, a touch sensor 320 and a display 350.

The case 310 is formed from a flat surface 311 and a curved surface 312. The flat surface 311 is a surface parallel with the X axis.

The flat surface 311 of the case 310 is provided with the display 350.

In addition, the curved surface 312 of the case 310 is provided with the strip-shaped touch sensor 320. Because, as described above, the strip-shaped touch sensor 320 is provided to the curved surface 312, the touch sensor 320 includes two points at which the respective normal lines to the touch sensor 320 are in directions opposite from each other.

In each of the above-described operation input devices 101, 201, 301, the user can perform various operations by touching the touch sensor at two points while holding the case held between the thumb and the finger, like in the operation input device 1.

Furthermore, like in the operation input device 1, the controller (not shown in some of the figures) in the case identifies the touch positions, movement amounts of the touch positions, and movement directions of the touch positions based on the touch position information outputted from the touch sensor as needed while the user is touching the touch sensor. The controller can then make control to show image display in which a state of an object represented by the image is changed based on the touch positions, the movement amounts of the touch positions, and the movement directions of the touch positions that have been identified.

As described above, this invention naturally includes various embodiments which are not described herein. Accordingly, the technical scope of this invention should be determined only by the matters to define the invention in the scope of claims regarded as appropriate based on the description.

The operation input device of this invention can be operated by a user while the case is stabilized, and thus is useful as an operation input device.

What is claimed is:

1. An operation input device comprising:
a case;
a planer display unit; and
a touch sensor configured to detect a touch position and provided at a position including at least two points at which normal lines to the touch sensor are in directions opposite from each other on a surface of the case perpendicular to an extending direction of the display unit.

2. The operation input device according to claim 1, wherein
the case is shaped like a rectangular solid, and
the touch sensor is provided on three of four side surfaces of the rectangular solid.

3. The operation input device according to claim 1, further comprising a display controller configured to control the display unit so that the display unit displays an image based on a result of touch position detection by the touch sensor.

4. The operation input device according to claim 3, wherein the display controller controls the display unit so that the display unit displays an image based on at least one of the touch position, a movement amount of the touch position, and a movement direction of the touch position that are detected by the touch sensor.

5. The operation input device according to claim 1, wherein the display unit is provided on the case.

6. The operation input device according to claim 3, wherein the display controller controls the display unit so that the display unit performs image display in which an object represented by an image is dragged, when at least two touch positions detected by the touch sensor move in a direction parallel with the extending direction of the display unit.

7. The operation input device according to claim 3, wherein the display controller controls the display unit so that the display unit performs image display in which an object represented by the image is grabbed, when at least two touch positions detected by the touch sensor move in a direction from the rear side to the front side of the display unit.

8. The operation input device according to claim 3, wherein the display controller controls the display unit so that the display unit performs image display in which an object represented by the image is pushed in, when at least two touch positions detected by the touch sensor move in a direction from the front side to the rear side of the display unit.

9. The operation input device according to claim 3, wherein the display controller controls the display unit so that the display unit performs image display in which an object represented by the image is twisted, when one of at least two touch positions detected by the touch sensor moves in a direction from the rear side to the front side of the display unit and the other thereof moves in a direction from the front side to the rear side of the display unit.

10. The operation input device according to claim 3, wherein the display controller controls the display unit so that the display unit displays an image in which an object represented by the image is pulled up, when at least two touch positions detected by the touch sensor move in a direction from the rear side to the front side of the display unit.

11. The operation input device according to claim 3, wherein the display controller controls the display unit so that the display unit displays an image in which an object represented by the image is pushed down, when at least two touch positions detected by the touch sensor move in a direction from the front side to the rear side of the display unit.
